(19) United States
(12) Patent Application Publication
(10) Pub. No.: US 2016/0078824 A1
(43) Pub. Date: Mar. 17, 2016

(54) DISPLAY APPARATUS POWER MANAGEMENT CONTROLLER AND METHODS OF OPERATION THEREOF

(71) Applicant: Pixtronix, Inc., San Diego, CA (US)

(72) Inventors: James Chester Meador, Berkeley, CA (US); Alan Gerald Lewis, Sunnyvale, CA (US)

(21) Appl. No.: 14/726,130

(22) Filed: May 29, 2015

Related U.S. Application Data
(60) Provisional application No. 62/048,991, filed on Sep. 11, 2014.

(51) Int. Cl. G09G 3/34

(52) U.S. Cl. CPC G09G 3/3433; G09G 2300/0828; G09G 2310/08; G09G 2330/021

(57) ABSTRACT

This disclosure provides systems, methods and apparatus for powering display light sources. A display can include a DC/DC converter included in a power management integrated circuit (PMIC) to serve as the light source driver. Battery current drawn by the DC/DC converter can be smoothed, in part, by introducing a capacitor in parallel with the set of light sources. A display controller can control the DC/DC converter to output a substantially constant current for substantially the entirety of a time period for displaying a set of subframes, storing enough charge on the capacitor to support the current drawn through the light sources by a digital-to-analog converter included in the PMIC. Output current level for the DC/DC converter can be determined for the time period over which the subframes are displayed. The set of subframes can include subframes of a single image frame, or of one or more image frames.

### CROSS-REFERENCE TO RELATED APPLICATIONS

This patent application claims priority to U.S. Provisional Patent Application No. 62/048,991 entitled “Display Apparatus Power Management Controller and Methods of Operation thereof,” filed Sep. 11, 2014, assigned to the assignee hereof and hereby expressly incorporated by reference herein.

### TECHNICAL FIELD

This disclosure relates to the field of imaging displays, and in particular to image formation processes for multi-primary displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display apparatus can include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including a first set of light sources including a first terminal and a second terminal, and a first capacitor, coupled to the first terminal of the first set of light sources. The apparatus further includes a power management device receiving power from a DC voltage source. The power management device includes a first digital-to-analog converter (DAC) coupled to the first terminal of the first set of light sources. The first DAC is configured to cause a plurality of current pulses to flow from the first set of light sources to illuminate the light sources for a first plurality of subframes during a first time period and for a second plurality of subframes during a second time period. The power management device also includes a first programmable DC/DC converter, an output of which is coupled to the second terminal of the first set of light sources and to the first capacitor. The first programmable DC/DC converter is configured to draw a first substantially constant current from the DC voltage source and provide a first substantially constant output current over substantially the entirety of the first time period, and to draw a second substantially constant current, different from the first substantially constant current, from the DC voltage source and provide a second substantially constant output current over substantially the entirety of the second time period.

In some implementations, the first plurality of subframe and the second plurality of subframes include subframes corresponding to a single image frame. In some implementations, at least one subframe of the first plurality of subframes corresponds to an image frame that is different from the image frame corresponding to another subframe of the first plurality of subframes. In some implementations, during the first time period a variation in the magnitude of the first substantially constant current at frequencies greater a frequency that is an order of magnitude larger than a switching frequency of the first programmable DC/DC converter is less than 2% of an average value of the first substantially constant current during the first time period. In some implementations, during the second time period a variation in the magnitude of the second substantially constant current at frequencies greater than a frequency that is an order of magnitude larger than a switching frequency of the first programmable DC/DC converter is less than 2% of an average value of the second substantially constant current during the second time period.

In some implementations, the apparatus further includes a display controller coupled to the power management device. The display controller is configured to provide control messages to the first DAC for causing the plurality of current pulses to flow from the first set of light sources, and to provide control messages to the first programmable DC/DC converter, the control messages including at least a current output level associated with each of the first time period and the second time period. In some implementations, the first programmable DC/DC converter is configured to provide the first substantially output current and the second substantially constant output current during each of the first time period and the second time period based on the respective current output level.

In some implementations, the control message further includes an output threshold voltage level associated with each of the first time period and the second time period, and where the first programmable DC/DC converter is configured to cease providing an output current during the first time period and the second time period when the output voltage exceeds the respective output threshold voltage level. In some implementations, the display controller is configured to estimate a total charge to be flowed through the first set of light sources in illuminating the first set of light sources for each of the first time period and the second time period. The display controller is further configured to provide the current output level for the first time period based on the total charge estimate for the first time period and provide the current output level for the second time period based on the total charge estimate for the second time period.

In some implementations, the control messages to the first DAC include values for magnitudes and durations of the current pulses. In some implementations, the first programmable DC/DC converter is configured to provide an output voltage equal to at least a minimum voltage needed for the operation of the first DAC. In some implementations, the apparatus further includes a second set of light sources including a first terminal and a second terminal. The second set of light sources corresponds to a color different from the color corresponding to the first set of light sources, and the second terminal of the second set of light sources is coupled to the output of the first programmable DC/DC converter and to the first capacitor. In some implementations, the power management device further includes a second digital-to-analog converter (DAC) coupled to the first terminal of the second set of light sources, where the second DAC is configured to cause a plurality of current pulses to flow from the second set of light sources over the first time period and the second time period.

In some implementations, the apparatus further includes a second set of light sources including a first terminal and a second terminal. The second set of light sources corresponds to a color different from the color corresponding to the first set of light sources. The apparatus further includes a second capacitor, one terminal of which is coupled to the first terminal of the second set of light sources. The power management device further includes a second digital-to-analog converter (DAC) coupled to the first terminal of the second set of light sources, where the second DAC is configured to cause a plurality of current pulses to flow from the second set of light sources over the first time period and the second time period. The power management device also includes a second programmable DC/DC converter, an output of which is coupled to the second terminal of the second set of light sources and to the second capacitor, where the second programmable DC/DC converter is configured to draw a third substantially constant current from the DC voltage source and provide a third substantially constant output current over the first time period, and draw a fourth substantially constant current, different from the third substantially constant current, from the DC voltage source and provide a fourth substantially constant output current over the second time period.

In some implementations the apparatus further includes a display, a processor capable of communicating with the display, the processor being capable of processing image data, and a memory device capable of communicating with the processor. In some implementations, the apparatus further includes a driver circuit capable of sending at least one signal to the display, and a controller capable of sending at least a portion of the image data to the driver circuit. In some implementations, the apparatus further includes an image source module capable of sending the image data to the processor, where the image source module includes at least one of a receiver, transceiver, and transmitter. In some implementations, the apparatus further includes an input device capable of receiving input data and communicating the input data to the processor.

Another innovative aspect of the subject matter described in this disclosure can be implemented in a method for providing power to a light source from a power management integrated circuit (PMIC), where the PMIC has an output terminal to which the light source and a capacitor are coupled. The method includes determining an output sequence for displaying a first plurality of subframes during a first time period and a second plurality of subframes during a second time period according to a time division multiplexing image formation process, where the output sequence indicates light source illumination levels and durations for each of the first and second plurality of subframes. The method further includes providing a plurality of current pulses to the light source from the PMIC, where the plurality of current pulses correspond to the first and the second plurality of subframes. The method also includes drawing a first substantially constant current from a DC voltage source powering the PMIC and providing a first substantially constant output current over substantially the entirety of the first time period. The method further includes drawing a second substantially constant current, different from the first substantially constant current, from the DC voltage source and providing a second substantially constant output current over substantially the entirety of the second time period.

In some implementations, determining an output sequence for displaying a first plurality of subframes during a first time period and a second plurality of subframes during a second time period includes determining an output sequence for displaying the first plurality of subframes and the second plurality of subframes in a single image frame. In some implementations, determining an output sequence for displaying a first plurality of subframes during a first time period and a second plurality of subframes during a second time period includes determining an output sequence for displaying at least one subframe of the first plurality of subframes during a first image frame and displaying another subframe of the first plurality of subframes during a second image frame, different from the first image frame.

In some implementations, drawing a first substantially constant current from the DC voltage source includes drawing a current, which during the first time period and at frequencies greater than a frequency that is an order of magnitude larger than a switching frequency of the PMIC, has variations in magnitude that are less than 2% of an average value of the current over the first time period. In some implementations, drawing a second substantially constant current from the DC voltage source includes drawing a current, which during the second time period and at frequencies greater than a frequency that is an order of magnitude larger than a switching frequency of the PMIC has variations in magnitude that are less than 2% of an average value of the current over the second time period.

In some implementations, providing the first substantially constant output current includes estimating a total charge to be flowed through the light source for illuminating the light source over the first time period and adjusting the level of the first substantially constant output current to sufficiently provide the estimated total charge over the first time period. In some implementations, providing the second substantially constant output current includes estimating a total charge to be flowed through the light source for illuminating the light source over the second time period and adjusting the level of the second substantially constant output current to sufficiently provide the estimated total charge over the second time period.

Another innovative aspect of the subject matter described in this disclosure can be implemented in an apparatus including first light emitting means for emitting light of a first color responsive to current flow, including a first terminal and a second terminal, where the first terminal is coupled to a first capacitor. The apparatus further includes a power management device receiving power from a DC voltage source. The power management device includes first digital-to-analog converting (DAC) means coupled to the first terminal of the first light emitting means for causing a plurality of current pulses to flow from the first light emitting means to illuminate the first light emitting means for a first plurality of subframes during a first time period and for a second plurality of subframes during a second time period. The power management device further includes first programmable DC/DC converting means, an output of which is coupled to the second terminal of the first light emitting means and to the first capacitor, for drawing a first substantially constant current from the DC voltage source and provide a first substantially constant output current over substantially the entirety of the first time period and for drawing a second substantially constant current, different from the first substantially constant current, from the DC voltage source and provide a second substantially constant output current over substantially the entirety of the second time period.

In some implementations, the first plurality of subframes and the second plurality of subframes include subframes corresponding to a single image frame. In some implementations, at least one subframe of the first plurality of subframes corresponds to an image frame that is different from the image frame corresponding to another subframe of the first plurality of subframes. In some implementations, the apparatus further includes display controlling means coupled to the power management device. The display controlling means provides control messages to the first DAC means for causing the plurality of current pulses to flow from the first light emitting means, and provides control messages to the first programmable DC/DC converting means, the control messages including at least a current output level associated with each of the first time period and the second time period. In some implementations, the first programmable DC/DC converting means is configured to provide an average output current during each of the first time period and the second time period based on the respective current output level.

In some implementations, the apparatus further includes a second light emitting means for emitting light of a second color responsive to current flow, including a first terminal and a second terminal, the second color being different from the first color, where the second terminal of the second light emitting means is coupled to the output of the first programmable DC/DC converting means and to the first capacitor. In some implementations, the power management device further includes a second digital-to-analog converting (DAC) means coupled to the first terminal of the second light emitting means for causing a plurality of current pulses to flow from the second set of light sources over the first time period and the second time period.

In some implementations, the apparatus further includes a second light emitting means for emitting light of a second color responsive to current flow, including a first terminal and a second terminal, the second color being different from the first color, and a second capacitor, one terminal of which is coupled to the first terminal of the second light emitting means. In some implementations, the power management device further includes a second digital-to-analog converting (DAC) means coupled to the first terminal of the second light emitting means for causing a plurality of current pulses to flow from the second light emitting means over the first time period and the second time period. The power management device also includes a second programmable DC/DC converting means, an output of which is coupled to the second terminal of the second set of light sources and to the second capacitor, for drawing a third substantially constant current from the DC voltage source and providing a third substantially constant output current over the first time period, and for drawing a fourth substantially constant current, different from the third substantially constant current, from the DC voltage source and providing a fourth substantially constant output current over the second time period.

Another innovative aspect of the subject matter described in this disclosure can be implemented in a non-transitory computer readable storage medium having instructions encoded thereon, which when executed by a processor cause the processor to perform a method for providing power to a light source from a power management integrated circuit (PMIC), the PMIC having an output terminal to which the light source and a capacitor are coupled. The method includes determining an output sequence for displaying a first plurality of subframes during a first time period and a second plurality of subframes during a second time period according to a time division multiplexing image formation process, the output sequence indicating light source illumination levels and durations for each of the first and second plurality of subframes. The method further includes providing a plurality of current pulses to the light source from the PMIC, the plurality of current pulses corresponding to the first and the second plurality of subframes. The method also includes drawing a first substantially constant current from a DC voltage source powering the PMIC and providing a first substantially constant output current over substantially the entirety of the first time period. The method further includes drawing a second substantially constant current, different from the first substantially constant current, from the DC voltage source and providing a second substantially constant output current over substantially the entirety of the second time period.

In some implementations, determining an output sequence for displaying a first plurality of subframes during a first time period and a second plurality of subframes during a second time period includes determining an output sequence for displaying the first plurality of subframes and the second plurality of subframes in a single image frame. In some implementations, determining an output sequence for displaying a first plurality of subframes during a first time period and a second plurality of subframes during a second time period includes determining an output sequence for displaying at least one subframe of the first plurality of subframes during a first image frame and displaying another subframe of the first plurality of subframes during a second image frame, different from the first image frame.

In some implementations, providing the first substantially constant output current includes estimating a total charge to be flowed through the light source for illuminating the light source over the first time period and adjusting the level of the first substantially constant output current to sufficiently provide the estimated total charge over the first time period, where providing the second substantially constant output current includes estimating a total charge to be flowed through the light source for illuminating the light source over the second time period and adjusting the level of the second substantially constant output current to sufficiently provide the estimated total charge over the second time period.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a block diagram of an example display apparatus.

FIG. 4 shows a block diagram of an example power management integrated circuit (PMIC).

FIGS. 5A and 5B show flow diagrams of example processes for operation of the DC/DC converter shown in FIG. 4.

FIG. 6 shows a flow diagram of an example process for determining a DC/DC converter output current.

FIG. 7 shows a flow diagram of an example process for determining a voltage threshold for the DC/DC converter included in the PMIC shown in FIG. 4.

FIGS. 8A and 8B show example PMICs that provide current to multiple strings of LEDs in parallel.

FIG. 9 shows example signal traces associated with the operation of a PMIC similar to that shown in FIG. 4.

FIG. 10 shows example signal traces associated with the operation of a PMIC similar to that shown in FIG. 4.

FIGS. 11A and 11B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Transmissive display apparatus employing time division gray scale and/or field sequential color (FSC) display processes generally drive their light sources in a highly pulsatile manner. For current-controlled light sources, such as light emitting diodes (LEDs), rapid and steep current changes are desired. Such rapid current changes however, can strain a battery attempting to power the drivers providing the requisite current. In some implementations, a DC/DC converter can be included in a power management integrated circuit (PMIC) to serve as the light source driver. Battery current drawn by the DC/DC converter can be smoothed by introducing a capacitor in parallel with the set of LEDs. A display controller can control the DC/DC converter to output a substantially constant current for substantially the entirety of an image frame or for an entirety of a time period for displaying a set of subframes, storing enough charge on the capacitor to support the current drawn through the light sources by a digital-to-analog converter included in the PMIC.

The display controller can determine the output current level for the DC/DC converter by calculating the total current to be output through the LEDs across all subframes of a set of subframes, and dividing that current by the total time allocated to the set of subframes. In some implementations, the set of subframes can include subframes associated with an entire image frame or subframes associated with one or more image frames. The output current can be calculated by the display controller for each of the sets of subframes based on the specifics of the output sequence determined by the display controller for output of the set of subframes. In some implementations, the display controller also can determine a voltage threshold level for the capacitor. If during the time period allocated to display a set of subframes, the voltage on the capacitor exceeds the threshold, the output of the DC/DC converter can be reduced or halted to avoid unnecessary power expenditure, until the voltage on the capacitor falls back below the threshold.

In some implementations, the display controller can calibrate the current output by the DC/DC converter according to a calibration process. The calibration can be a one-time calibration, or a process repeated throughout the lifetime of the display apparatus.

Particular implementations of the subject matter described in this disclosure can be implemented to realize one or more of the following potential advantages. The incorporation of a capacitor in parallel with a string of LEDs powered by a DC/DC converter combined with a determination of an average current output of the DC/DC converter for displaying a set of subframes allows the DC/DC converter to smooth its current output and its current draw from a battery powering the converter during the time period allocated for displaying the set of subframes. The smoothed draw from the battery protects the battery from undue strain. The capacitor also enables rapid response to changes in currents drawn by a DAC coupled to the LEDs. The inclusion of the capacitor further enables a DC/DC converter current output calibration process to provide more accurate current output.

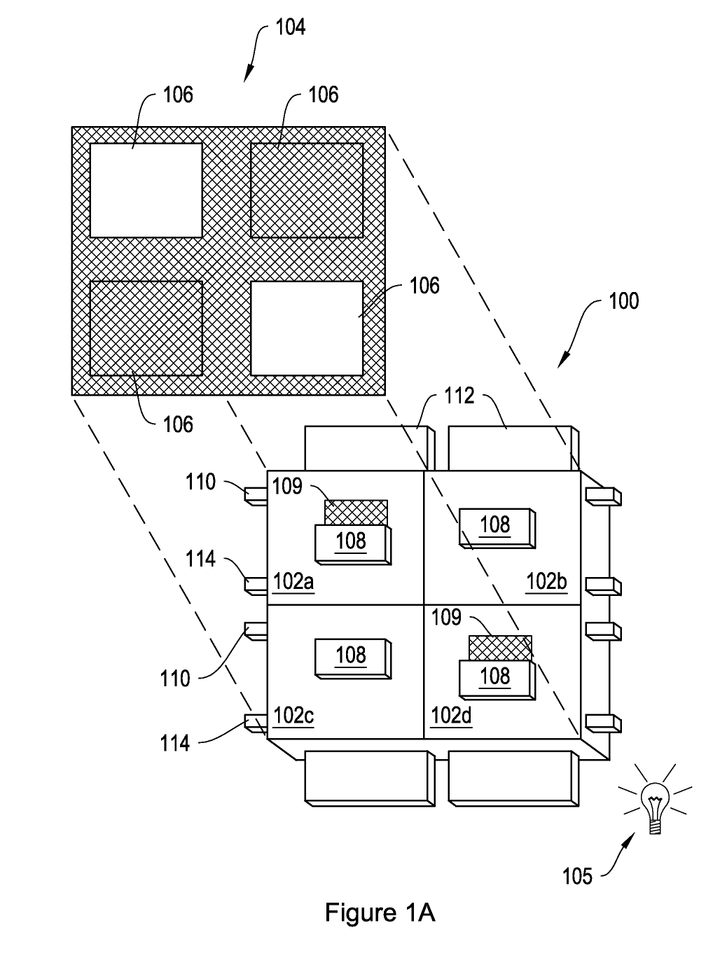

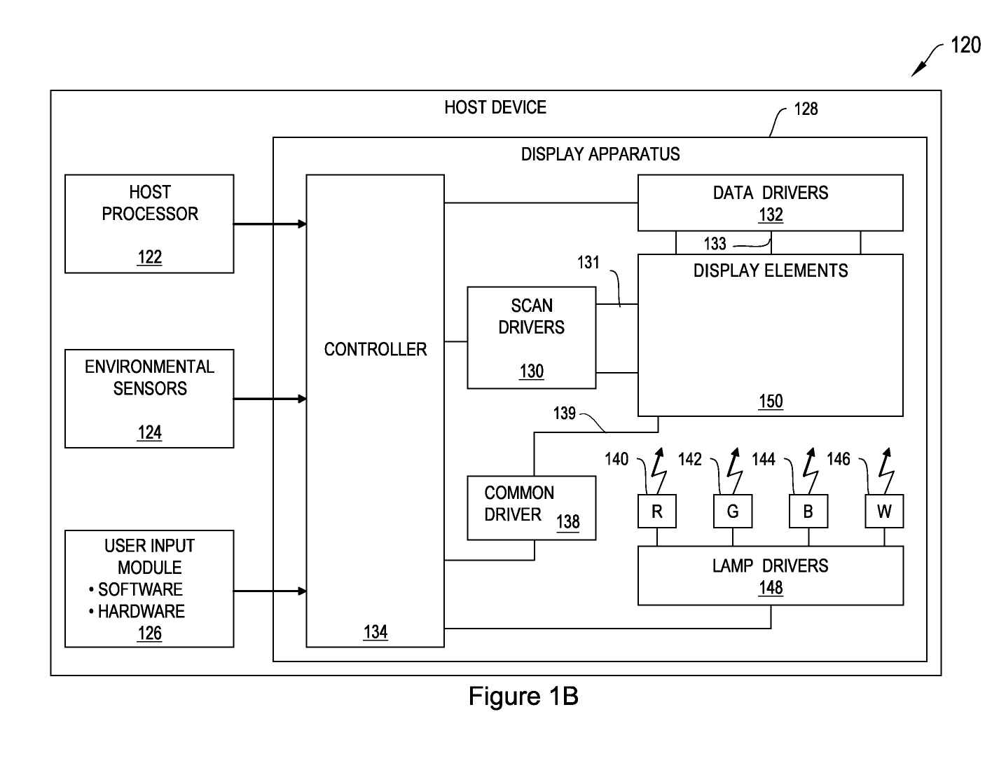

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a light guide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

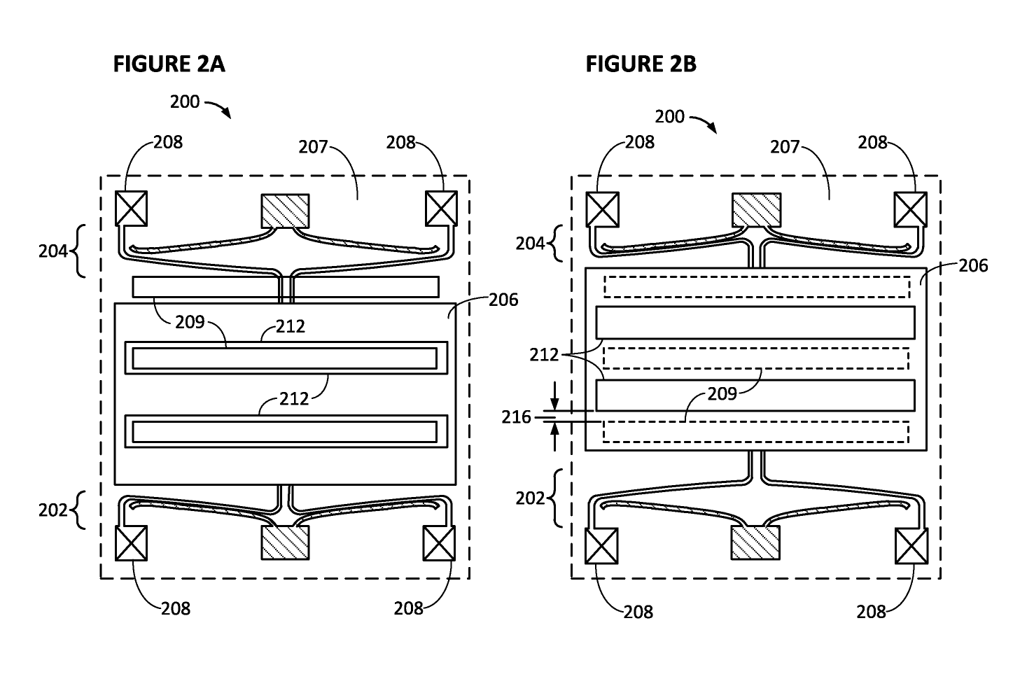

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

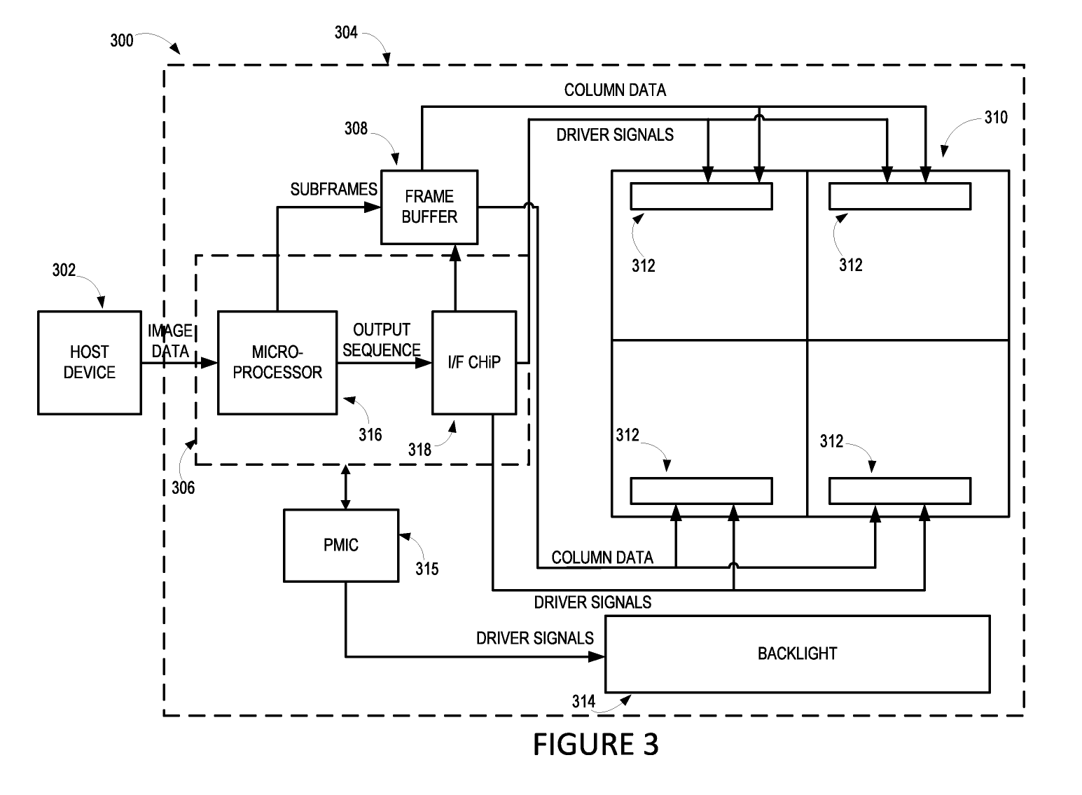

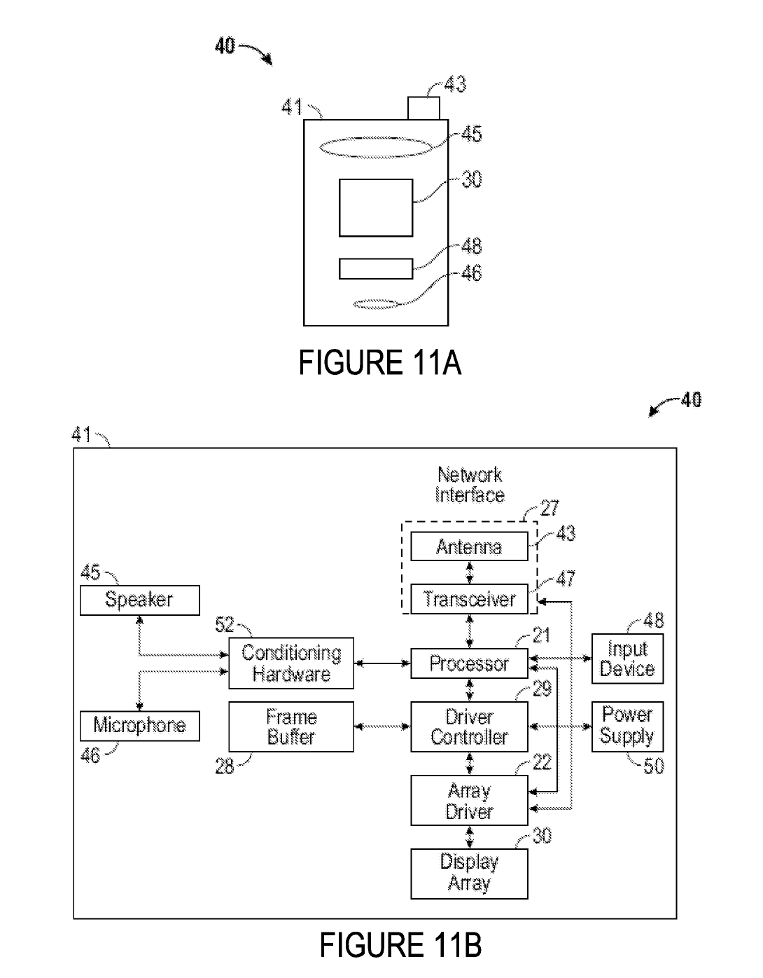

FIG. 3 shows a block diagram of an example display apparatus 300. The display apparatus 300 includes a host device 302 and a display module 304. The host device 302 can be an example of the host device 120 and the display module 304 can be an example of the display apparatus 128, both shown in FIG. 1B. The host device 302 can be any of a number of electronic devices, such as a portable telephone, a smartphone, a watch, a tablet computer, a laptop computer, a desktop computer, a television, a set top box, a DVD or other media player, or any other device that provides graphical output to a display, similar to the display device 40 shown in FIGS. 11A and 11B below. In general, the host device 302 serves as a source for image data to be displayed on the display module 304.

The display module 304 further includes control logic 306, a frame buffer 308, an array of display elements 310, display drivers 312, a backlight 314, and a power management integrated circuit (PMIC) 315. In general, the control logic 306 serves to process image data received from the host device 302 and controls the display drivers 312, array of display elements 310 and backlight 314 to together produce the images encoded in the image data. The control logic 306, frame buffer 308, array of display elements 310, and display drivers 312 shown in FIG. 3 can be similar, in some implementations, to the driver controller 29, frame buffer 28, display array 30, and array drivers 22 shown in FIGS. 11A and 11B, below. In general, the PMIC controls the delivery of power from a battery (not shown) to the display drivers 312 as well as the light sources included in the backlight 314.

In some implementations, as shown in FIG. 3, the functionality of the control logic 306 is divided between a microprocessor 316 and an interface (I/F) chip 318. In some implementations, the interface chip 318 is implemented in an integrated circuit logic device, such as an application specific integrated circuit (ASIC). In some implementations, the microprocessor 316 is configured to carry out all or substantially all of the image processing functionality of the control logic 306. In addition, the microprocessor 316 can be configured to determine an appropriate output sequence for the display module 304 to use to generate received images. For example, the microprocessor 316 can be configured to convert image frames included in the received image data into a set of image subframes. Each image subframe can be associated with a color and a weight, and includes desired states of each of the display elements in the array of display elements 310. The microprocessor 316 also can be configured to determine the number of image subframes to display to produce a given image frame, the order in which the image subframes are to be displayed, timing parameters associated with addressing the display elements in each subframe, and parameters associated with implementing the appropriate weight for each of the image subframes. These parameters may include, in various implementations, the duration for which each of the respective image subframes is to be illuminated and the intensity of such illumination. The collection of these parameters (i.e., the number of subframes, the order and timing of their output, and their weight implementation parameters for each subframe) can be referred to as an “output sequence.”

The interface chip 318 can be capable of carrying out more routine operations of the display module 304. The operations may include retrieving image subframes from the frame buffer 308 and outputting control signals to the display drivers 312 and the backlight 314 in response to the retrieved image subframe and the output sequence determined by the microprocessor 316. In some other implementations, the functionality of the microprocessor 316 and the interface chip 318 are combined into a single logic device, which may take the form of a microprocessor, an ASIC, a field programmable gate array (FPGA) or other programmable logic device. For example, the functionality of the microprocessor 316 and the interface chip 318 can be implemented by a processor 21 shown in FIG. 11B. In some other implementations, the functionality of the microprocessor 316 and the interface chip 318 may be divided in other ways between multiple logic devices, including one or more microprocessors, ASICs, FPGAs, digital signal processors (DSPs) or other logic devices.

The frame buffer 308 can be any volatile or non-volatile integrated circuit memory, such as DRAM, high-speed cache memory, or flash memory (for example, the frame buffer 308 can be similar to the frame buffer 28 shown in FIG. 11B). In some other implementations, the interface chip 318 causes the frame buffer 308 to output data signals directly to the display drivers 312. The frame buffer 308 has sufficient capacity to store color subfield data and subframe data associated with at least one image frame. In some implementations, the frame buffer 308 has sufficient capacity to store color subfield data and subframe data associated with a single image frame. In some other implementations, the frame buffer 308 has sufficient capacity to store color subfield data and subframe data associated with at least two image frames. Such extra memory capacity allows for additional processing by the microprocessor 316 of image data associated with a more recently received image frame while a previously received image frame is being displayed via the array of display elements 310.

In some implementations, the display module 304 includes multiple memory devices. For example, the display module 304 may include one memory device, such as a memory directly associated with the microprocessor 316, for storing subfield data, and the frame buffer 308 is reserved for storage of subframe data.

The array of display elements 310 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS- or MEMS-based light modulators, or light emitters, such as OLED emitters, configured for use with a time division gray scale image formation process.

The display drivers 312 can include a variety of drivers depending on the specific control matrix used to control the display elements in the array of display elements 310. In some implementations, the display drivers 312 include a plurality of scan drivers similar to the scan drivers 130, a plurality of data drivers similar to the data drivers 132, and a set of common drivers similar to the common drivers 138, as shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 304, the control matrix used to control the display elements in the array of display elements 310 is segmented into multiple regions. For example, the array of display elements 310 shown in FIG. 3 is segmented into four quadrants. A separate set of display drivers 312 is coupled to each quadrant. Dividing a display into segments in this fashion can reduce the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, such as the backlight 314, which is illuminated by one or more lamps. Such display elements can be fabricated on transparent substrates, made, for example, from glass. In some implementations, the display drivers 312 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring. For example, in some implementations, the display drivers 312 can be included within the PMIC 315.

The backlight 314 can include a light guide and one or more light sources (such as LEDs). The light sources can include light sources of multiple colors, such as red, green, blue, and in some implementations white. The light sources are driven by components within the PMIC 315, which are capable of driving the light sources to a plurality of discrete light levels to enable illumination gray scale and/or content adaptive backlight control (CABC) in the backlight. In addition, lights of multiple colors can be illuminated simultaneously at various intensity levels to adjust the chromaticities of the component colors used by the display, for example to match a desired color gamut. Lights of multiple colors also can be illuminated to form composite colors. For displays employing red, green, and blue component colors, the display may utilize a composite color white, yellow, cyan, magenta, or any other color formed from a combination of two or more of the component colors.

The light guide distributes the light output by light sources substantially evenly beneath the array of display elements 310. In some other implementations, for example for displays including reflective display elements, the display apparatus 300 can include a front light or other form of lighting instead of a backlight. The illumination of such alternative light sources can likewise be controlled according to illumination gray scale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

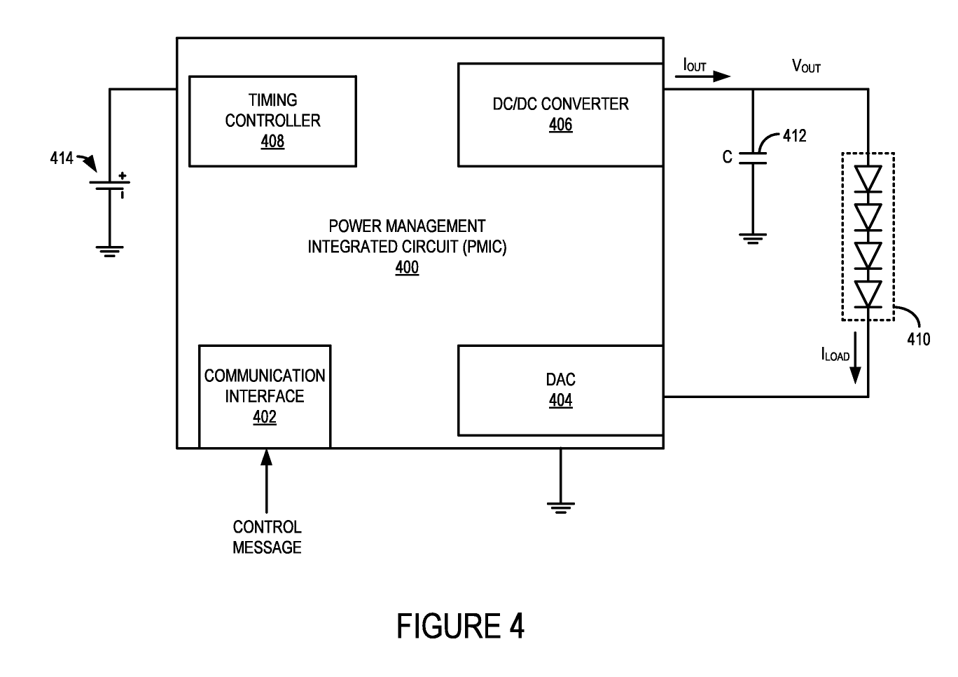

FIG. 4 shows a block diagram of an example PMIC 400. The PMIC 400 can be suitable for use as the PMIC 315 shown in FIG. 3. The PMIC 400 includes a communication interface 402, a digital-to-analog converter (DAC) 404, a DC/DC converter 406, and a timing controller 408. The communication interface 402 links the PMIC 400 to a display controller (not shown), such as the control logic 306 shown in FIG. 3. The DAC 404 can include a current output DAC that draws an electrical current, the magnitude of which corresponds to a digital current value. In some implementations, the DAC 404 can include current sources, such as current mirrors, that can be selectively switched ON such that the total current drawn by the current sources corresponds to the digital current value. In some implementations, the DC/DC converter 406 can be a linear or a switched circuit DC to DC voltage converter. In some implementations, the DC/DC converter 406 can be a step-up or a step-down voltage converter. In some implementations, the DC/DC converter 406 can be a switched circuit DC to DC boost converter. The DC/DC converter 406 can receive power from a battery 414 and provide an output current I_{OUT} and an output voltage V_{OUT}. In some implementations, the DC/DC converter 406 can provide the output current I_{OUT} and the output voltage V_{OUT} based on received output current and output voltage values. The timing controller can include analog or digital timers that generate trigger signals to the DAC 404 to initiate current flow through the string of LEDs.

The PMIC 400 is coupled to a string of light emitting diodes (LEDs) 410 and a capacitor 412. The DC/DC converter 406, the timing controller 408, and the DAC 404 together control the current flow through the LEDs 410 to control their illumination. More particularly, the DAC 404 controls the magnitude of the current pulled through the LEDs 410 and the timing controller 408 controls the timing of the current flow. The DC/DC converter 406 serves as a voltage controlled current source, regulating the power drawn from the display's battery 414 and storing charge on the capacitor 412, which can be used to provide the current pulled by the DAC 404.

The communication interface 402 can be a serial interface or any other form of communication interface, such as a digital bus, a universal serial bus (USB), THUNDERBOLT, parallel port, or other communication interface suitable for communicating control instructions from the display controller to the PMIC 400. In some implementations, the PMIC 400 and the microprocessor 316 and/or the I/F chip 318 shown in FIG. 3 can be coupled to a shared printed circuit board, connected by interconnects formed therein. The communication interface receives control messages from the display controller indicating the magnitudes, durations, and number of current pulses to be drawn through the LEDs 410 by the DAC 404. The control messages also can include current and voltage levels to be output by the DC/DC converter 406 along with maximum voltages to be maintained on the capacitor 412.

In some implementations, the control messages can be received on a frame-by-frame basis, or more or less frequently, such as for a select number of subframes. For example, as described above, control logic implemented in a display controller can execute CABC. CABC adjusts the backlight brightness used to illuminate each color subfield of each image frame based on the content of that image frame. For image frames that include a lower intensity of one particular color subfield, the display controller can instruct the PMIC 400 to illuminate the LEDs 410 associated with that color subfield at a lower current amplitude. In addition, control logic in the display controller can implement a display process that includes identifying a frame-specific contributing color for each image frame. The image frame is displayed using a combination of the frame-specific contributing color along with one or more frame-independent contributing colors. In some implementations, the display controller may adjust the magnitude, timing, and number of current pulses to be drawn through the LEDs 410 based on a variety of other factors, including ambient temperature, LED temperature, ambient light levels, user or controller selected display modes, etc. In any of such implementations, the magnitude and duration of the current pulses drawn through the LEDs 410 for each subframe of an image frame may vary from image frame to image frame. The PMIC 400 is notified of such changes through the control messages.

The capacitor 412 coupled to the output of the DC/DC converter is included to mitigate the potential adverse impacts the pulsatile nature of the current flow through the LEDs 410 can have on the display's battery 414. Without something to smooth out the current flow, the draw on the battery 414 would also be highly pulsatile, which could reduce the life of the battery 414. Attempting to rapidly modify the power draw on the battery 414 also can impede the rapid response times desired for the LEDs 410. A properly selected capacitor 412, on the other hand, can respond to rapid changes in current draw. In addition, with such a capacitor 412, the DC/DC converter 406 can output a substantially constant current with a magnitude that is less than the peak current of any particular peak current level through the LEDs 410, thereby smoothing current draw on the battery 414.

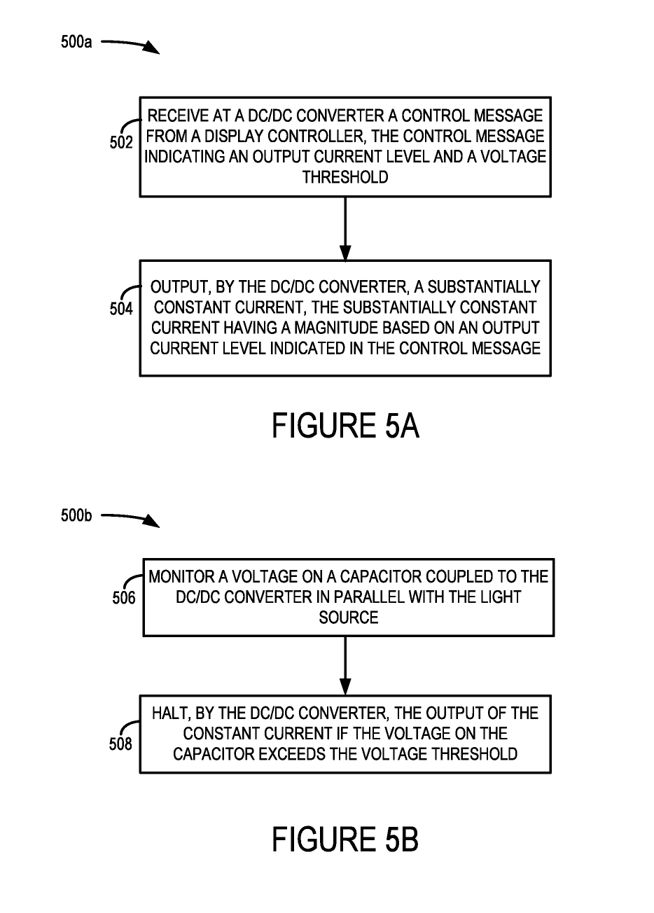

FIGS. 5A and 5B show flow diagrams of example processes 500a and 500b, respectively, for operation of the DC/DC converter 406 shown in FIG. 4. In particular, the process 500a includes receiving, at a DC/DC converter, a control message from a display controller, the control message indicating an output current level and a voltage threshold (stage 502) and outputting, by the DC/DC converter, a substantially constant current, the substantially constant current having a magnitude based on an output current level indicated in the control message (stage 504). The process 500b includes monitoring a voltage on a capacitor coupled to the DC/DC converter and to the light source (stage 506) and halting, by the DC/DC converter, the output of the constant current if the voltage on the capacitor exceeds the voltage threshold (stage 508).

Referring to FIG. 5A, the process 500a includes the DC/DC converter receiving a control message from a display controller (stage 502). As indicated above in relation to FIG. 4, the PMIC 400 can receive control messages from the display controller via the communication interface 402. The control messages can include a output current level for the DC/DC converter 406 as well as a voltage threshold for the capacitor 412 coupled to its output. The voltage threshold is selected to reduce power loss that might be lost as heat at the DAC 404 if the voltage across the capacitor 412 was raised to an overly high voltage. The process 500a further includes outputting a substantially constant current having a magnitude based on the output current level indicated in the control message. As mentioned above, the DC/DC converter 406 can output a constant output current based on the output current level or magnitude included in the control message.

Referring to FIG. 5B, the process 500b includes monitoring a voltage on a capacitor coupled to the DC/DC converter (stage 506). The DC/DC converter 406 can monitor the voltage across the capacitor and compare the voltage to the voltage threshold received in the control message. In response to detecting the voltage across the capacitor exceeding the voltage threshold (Vₜₕᵣₑₛₕ), the current output by the DC/DC converter is reduced to zero (or some other lower current level) (stage 508) until the voltage falls back below the voltage threshold. Otherwise, the DC/DC converter continues to output the identified current level until a new control message is received indicating a change in output current level. The output current level indicated in the control message can be based on the total current to be drawn through the LEDs 410 over a given time period, such as, for a single image frame, or for a duration over which a plurality of subframes of one or more image frames are displayed.

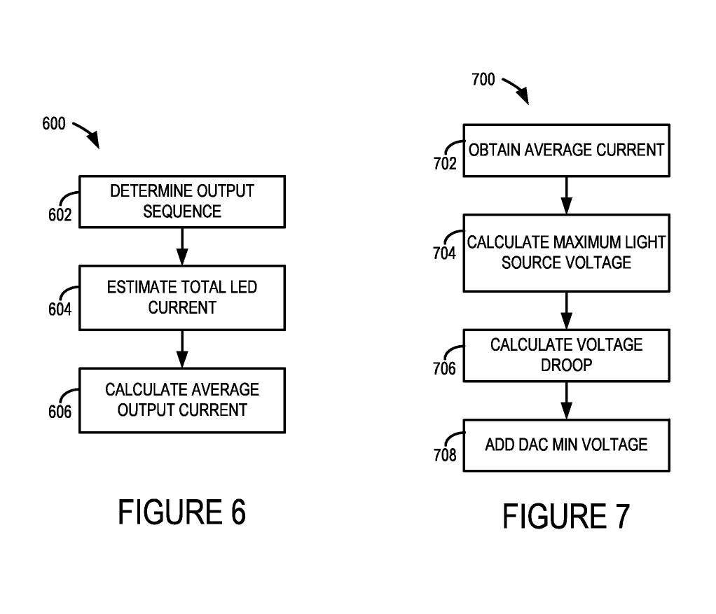

FIG. 6 shows a flow diagram of an example process 600 for determining a DC/DC converter output current. The process 600 can be carried out by a display controller coupled to the PMIC 400 shown in FIG. 4. The process 600 includes determining an output sequence for the image frame (stage 602), estimating a total charge to be flowed through the LEDs in illuminating the image frame using the output sequence (stage 604), and calculating an average output current (stage 606).

The process 600 includes determining an output sequence for an image frame (stage 602). The output sequence includes a number of subframes for each color subfield to be used for outputting the image frame. It also includes an intensity level for each set of LEDs for each subframe. As the chromaticities of the LEDs 410 tend to be more saturated than the colors desired for the subfields, each subframe is usually illuminated with one color at a relatively high intensity, with other colored LEDs being illuminated at a lower intensity to desaturate the color to the desired chromaticity of the subfield. Thus, for any given subframe, the display controller can identify intensities for red, green, blue, and white LEDs. The intensity levels can be transformed into corresponding calculated current levels, or discrete nominal values corresponding to desired current levels. As LEDs are temperature sensitive, the intensity levels can be further adjusted based on the ambient temperature levels or LED temperature levels.

Given the determined intensity levels for a given color, the display controller can estimate the total charge needed to achieve the desired intensity levels for each of the subframes of the image frame. In some implementations the total charge can be estimated as follows:

$${Q}_{total} = {\sum }_{1}^{n} {I}_{SFn} \times {t}_{SFn} ,$$

where I_{SFn} corresponds to the magnitude of the current pulse used to illuminate a given subframe n and t_{SFn} corresponds to the illumination duration of the subframe.

The display controller then calculates an average current for the DC/DC converter to output over the image frame by dividing the total charge Qₜₒₜₐₗ by the total time of the image frame, including the illumination times of the subframes as well as any time associated with addressing and/or actuating the display elements of the display while the display is not illuminated. In some implementations, the display controller calculates the average current for the DC/DC converter to output over a number of subframes instead of an entire image frame. In some such implementations, the total charge Qₜₒₜₐₗ can be determined for the number of subframes, and the average current for those subframes can be determined by dividing the total charge Qₜₒₜₐₗ by the total time period for displaying the subframes. In some implementations, the subframes over which the average current is determined can include subframes from a single image frame, or sequential subframes that span two or more image frames.

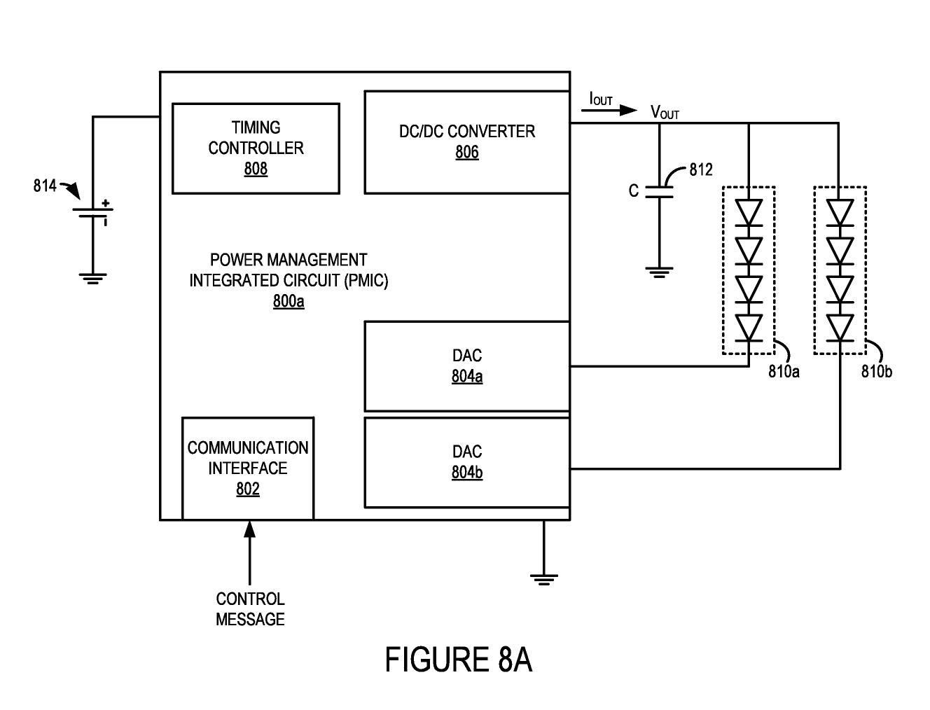

FIG. 7 shows a flow diagram of an example process 700 for determining a voltage threshold for the DC/DC converter 406 included in the PMIC 400 shown in FIG. 4. The process includes determining the average current output by the DC/DC converter 406 (stage 702), calculating a maximum voltage drop across the LEDs 410 coupled to the DC/DC converter 406 (stage 704), calculating a voltage droop during the image subframe (stage 706), and adding a minimum voltage needed to maintain proper operation of the DAC 404 to the maximum voltage drop and the maximum string voltage (stage 708).

The process 700 includes determining an average current to be output by the DC/DC converter 406 (stage 702). The average current can be calculated, for example, using the process 600 shown in FIG. 6.

The process 700 includes determining a maximum voltage drop across the LEDs 410 during the subframe (stage 704). The maximum voltage drop is equal to the maximum current amplitude across the subframes of the image frame multiplied by the combined resistance of the LEDs 410. In some implementations where the average current is determined for a selected number of subframes instead of on an image frame-by-image frame basis, the maximum voltage drop can be equal to the maximum current amplitude across the selected number of subframes multiplied by the combined resistance of the LEDs 410. The resistance is based in part on a measured temperature of the LEDs 410.

The process 700 also includes calculating the voltage droop across the display of the image frame (stage 706). The voltage droop corresponds to the voltage difference between the highest voltage needed on the capacitor 412 to provide the desired output currents given the DC/DC converter 406 current output and the lowest voltage on the capacitor 412 during the image frame or the time period over which the selected number of subframes are displayed. The voltage droop is estimated by calculating the change in the voltage of the capacitor 412 after each current pulse caused to be flowed through the LEDs 410. These voltage changes can be calculated as follows:

$$Δ {V}_{cap - n} = \frac{( {I}_{out} - {I}_{load - n} ) \cdot {pulselength}_{n}}{C} ,$$

Iₒᵤₜ represents the output current of the DC/DC converter 406. In some implementations, for example, Iₒᵤₜ can be the average output current of the DC/DC converter determined above (in relation to stage 702). I_{load-n} represents the average current through the LEDs 410 during the time period pulselengthₙ, where pulselengthₙ represents the duration of the current pulse. In some implementations, for example, the pulselengthₙ represents the time period between the instant the n^{th} current pulse begins and the instant the following (n+1)^{th} current pulse begins. C is the capacitance of the capacitor 412. These changes are summed sequentially over the frame or the time period over which the selected number of subframes are displayed, and the sum at each step (for example, at the beginning of each current pulse) predicts the capacitor 412 voltage at that point in the pulse sequence. That is, the transient voltage on the capacitor 412 after the nth current pulse can be calculated as follows:

$${V}_{cap - n} = {\sum }_{1}^{n} Δ {V}_{cap - n}$$

where, V_{cap-n} represents the net voltage across the capacitor 412 after each pulselengthₙ. The display controller can use this function to identify the maximum and minimum values of this function for all values of n between one and the total number of subframes in an image frame or the time period over which the selected number of subframes are displayed. The estimated voltage droop is the difference between the minimum and maximum values of this sequential summation. That is, the estimated voltage droop is the difference between the minimum, min(V_{cap-n}) and the maximum max(V_{cap-n}) values of the net voltage V_{cap-n} across the capacitor 412.

The voltage threshold is then set to the sum of the maximum voltage drop across the LEDs (determined in stage 704), the voltage droop (determined in stage 706), and a minimum voltage needed to maintain proper operation of the DAC 404.

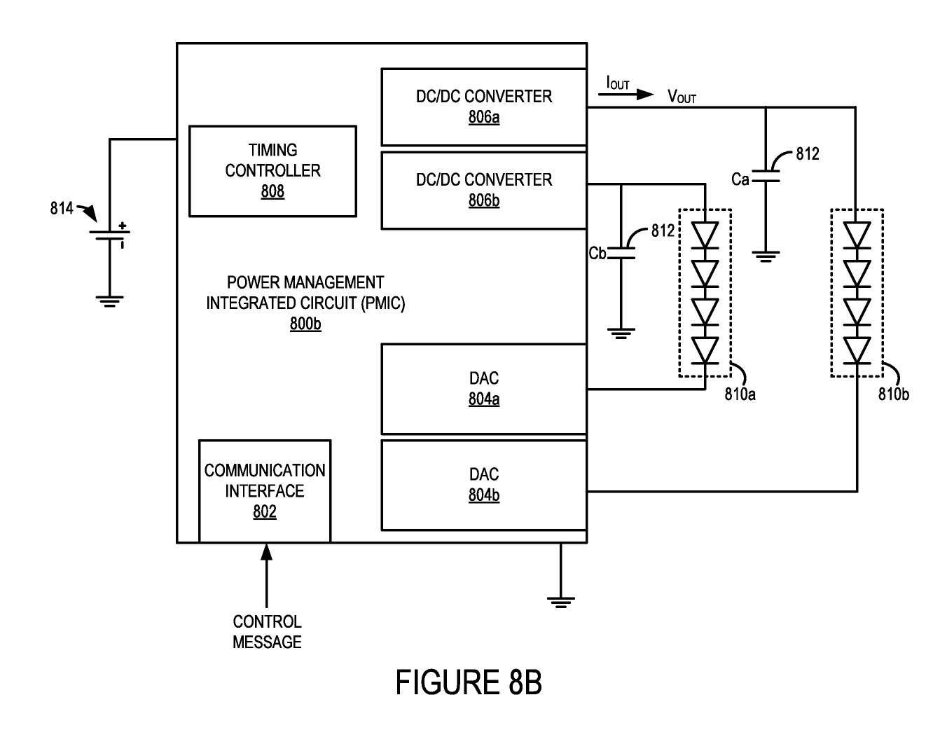

The above processes are described assuming that one color of LEDs 410 is coupled to the DC/DC converter 406. In such implementations, the PMIC 400 would include one DC/DC converter 406 for each color LED. The display controller would determine the operating parameters of each DC/DC conversion separately. In some implementations, for example for segmented displays, the PMIC 400 may include a separate DC/DC converter for each independently controlled set of LEDs. In some other implementations, multiple sets of independently controlled LEDs are fed by a common DC/DC converter (as described below in relation to FIG. 8A). In some other implementations, multiple separately controlled DC/DC converters may output current to the same capacitor. In some such implementations, each DC/DC converter may output a different current and utilize a different voltage threshold.

In some implementations, as described above in relation to FIG. 5 (stage 510), the DC/DC converter 406 can halt the output of the constant current if the voltage across the capacitor exceeds the voltage threshold. In some instances, the discontinuities in the output current may result in an increase in the ripple seen on the output current. In some instances, the ripple on the output current also may result in ripples in the current drawn from the battery. In some implementations, the voltage threshold can be set to a value higher than the one determined above. In some such implementations, the output current by the DC/DC converter would be substantially continuous and would not be halted based on the voltage across the capacitor. As a result, the ripple seen on the output current can be even lower. In some implementations, the message received from the display controller via the communication interface 402 may not include a threshold voltage for the capacitor, thereby allowing the PMIC 400 to operate without interrupting the output current, thereby reducing the output current ripple.

FIGS. 8A and 8B show example PMICs 800a and 800b that provide current to multiple strings of LEDs. In particular, FIG. 8A shows an example PMIC 800a in which a single DC/DC converter feeds current to multiple strings of LEDs in parallel, while FIG. 8B shows an example PMIC 800b in which multiple DC/DC converters feed current individually to their corresponding LED strings. Both the PMICs 800a and 800b include separate DACs for each set of LEDs. Referring to FIG. 8A, the PMIC 800a provides current to two strings of LEDs: a first string of LEDs 810a and a second string of LEDs 810b. The PMIC 800a includes a first DAC 404a and a second DAC 404b connected to the first string 810a and the second string 810b of LEDs, respectively. The PMIC 800a also includes a communication interface 802, a DC/DC converter 806, and a timing controller 808. A battery 814 provides power to the PMIC 800a. The PMIC 800a is also connected to a capacitor (C) 812. The communication interface 802, the DC/DC converter 806, the timing controller 808, and the battery 814 can be similar to the communication interface 402, the DC/DC converter 406, the timing controller 408, and the battery 414, respectively, discussed above in relation to FIG. 4. The capacitor 812 also can be similar to the capacitor 412 shown in FIG. 4, however, in some implementations, based on the current drawn by the strings of LEDs 810a and 810b, the value of the capacitor 812 may be larger than the value of the capacitor 412.

The DC/DC converter 806 is capable of outputting sufficient current to the capacitor 812 such that both strings of LEDs 810a and 810b can be provided sufficient current from the capacitor 812 so as to avoid rapid changes in current draws from the display battery 814. For example, the process 600 shown in FIG. 6 can be adapted to identify an average current sufficient to provide the total current to be used by the combined strings of LEDs 810a and 810b across the image frame or the time period over which the selected number of subframes are displayed. The process 700 shown in FIG. 7 also can be adapted as necessary to take into account the voltage drops across the full set of LEDs in each subframe.

The PMIC 800b includes a first DC/DC converter 806a and a second DC/DC converter 806b corresponding to the first string of LEDs 810a and the second string of LEDs 810b, respectively. PMIC 800b also includes a first capacitor 812a coupled to the first DC/DC converter 806a and a second capacitor 812b coupled to the second DC/DC converter 806b. Similar to the PMIC 800a shown in FIG. 8B, the PMIC 800b shown in FIG. 8B includes a first DAC 404a and a second DAC 404b connected to the first string 810a and the second string 810b of LEDs, respectively. The communication interface 802, the timing controller 808, and the battery 814 can be similar to the corresponding components in the PMIC 800a shown in FIG. 8A.

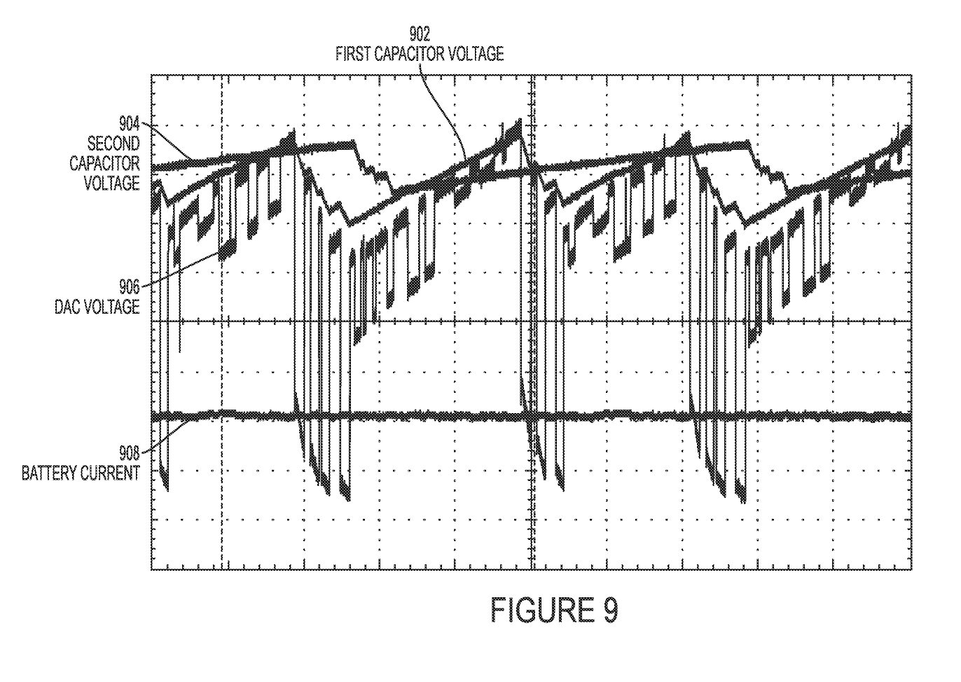

FIG. 9 shows example signal traces associated with the operation of a PMIC similar to that shown in FIG. 8B. In particular, FIG. 9 shows a first capacitor voltage signal trace 902, a second capacitor voltage signal trace 904, a first DAC voltage signal trace 906, and a battery current signal trace 908. As an example, the first capacitor voltage signal trace 902 and the second capacitor voltage signal trace 904 can represent to the voltage across the first capacitor 812a and the second capacitor 812b, respectively, shown in FIG. 8A. Further, the first DAC voltage signal trace 906 and the battery current signal trace 908 can represent the voltage at the first DAC 404a and the current output of the battery 814, respectively. As can be seen, while the first DAC voltage signal trace 906 has narrowly and steeply defined pulses the current drawn on the battery is substantially constant. In particular, the narrow pulses in the first DAC voltage signal trace 906 may correspond to the subframes during which the first LED string 810 is illuminated.

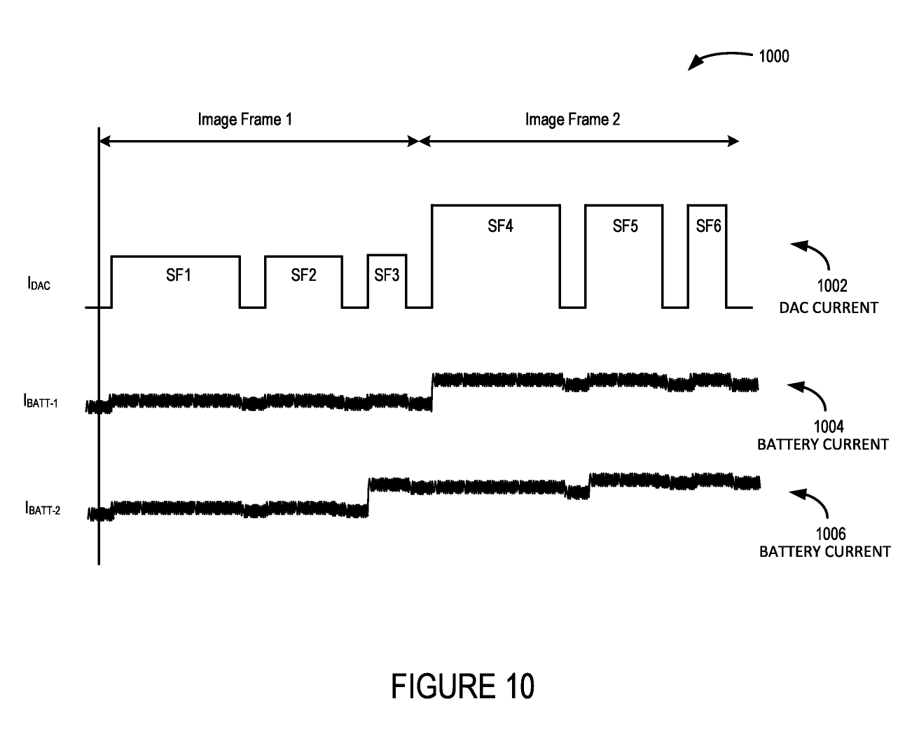

FIG. 10 shows example signal traces 1000 associated with the operation of a PMIC similar to that shown in FIG. 4. In particular, FIG. 10 shows a DAC current signal trace (I_{DAC}) 1002, a first battery current signal trace (I_{BATT-1}) 1004, and a second battery current signal trace (I_{BATT-2}) 1006. The DAC current signal trace 1002 can represent, for example, the current drawn by the DAC 404 shown in FIG. 4, the first battery current signal trace 1004 can represent, for example, the current drawn from the battery 414 in implementations where the average current is determined on an image frame-to-image frame basis. The second battery current signal trance 1006 can represent the current drawn from the battery 414 in implementations where the average current is determined over a selected number of subframes that can include subframes over one or more image frames.

The example signal traces 1000 are shown over two image frames: Image Frame 1 and Image Frame 2. As discussed above, each image frame can include a plurality of subframes during which the string of LEDs are illuminated. I_{DAC} 1002 shows the current drawn by the DAC to illuminate the string of LEDs during three subframes SF1, SF2, and SF3 in Image Frame 1, and three subframes SF4, SF5, and SF6 in Image Frame 2. The DAC current drawn in each of the subframes SF4, SF5, and SF6 is relatively higher than the current drawn in the subframes SF1, SF2, and SF3. The first battery current signal trace 1004 shows the current drawn from the battery 414 for an example implementation where the average current is determined for the complete Image Frame 1 and the complete Image Frame 2. The second battery current signal trace 1006 shows the current drawn from the battery 414 of an example implementation where the average current is determined separately for three separate sets of subframes: a first set including subframes SF1 and SF2, a second set including subframes SF3 and SF4, and a third set including subframes SF5 and SF6.

As shown in FIG. 10, large variations in the current drawn by the DACs result in relatively small variations in current drawn from the battery. In particular, as shown in the first battery current signal trace 1004, as the average current drawn by the DACs in the Image Frame 2 is greater than that in Image Frame 1, the average current drawn from the battery during Image Frame 2 is also greater than that during the Image Frame 2. However, in Image Frame 2 as well, the current drawn from the battery is substantially constant and has relatively small variations compared to the variations in the current drawn by the DAC. Similarly, as shown in the second battery current signal trace 1006, the average current drawn from the battery for different sets of subframes can be different, but each average current for the time period for each of the sets of subframes is substantially constant and has relatively small variations compared to the variations in the current drawn by the DAC during the respective sets of subframes. This reduction in the variations in the current drawn from the battery is, as discussed above, the result of the PMIC smoothening the pulsating current drawn by the DAC. As used herein, the current drawn from the battery or the output current provided by the DC/DC converter is considered to be substantially constant during a time period, if, during the time period the variation in the magnitude of the current at frequencies greater than a frequency that is an order of magnitude larger than the switching frequency of the DC/DC converter (such as, the DC/DC converters 406, 806, 806a, or 806b shown in FIGS. 4, 8A, and 8B) is less than 2% of the average of that current during the time period. In some implementations, the magnitude of the variations in the current can be equal to or less than about 250 mA from the average current over the time period.

In some implementations, a display controller can further be configured to calibrate the current output of the DC/DC converter (such as DC/DC converters 406 and 806 shown in FIGS. 4 and 8, respectively) of the PMIC (such the PMICs 400, 800a, and 800b shown in FIGS. 4, 8A, and 8B, respectively) to account for variability in the PMIC manufacturing process. In some implementations, the calibration can be carried out as a one-time calibration at the time of manufacture of the display apparatus. In some implementations, the display controller can be configured to execute the calibration process throughout the life of the display, for example at device start-up, and/or on a regular or irregular basis. The calibration process includes charging the capacitor (such as the capacitor 412 and 812 shown in FIGS. 4 and 8, respectively) coupled to the DC/DC converter to a target voltage level. The DAC (such as the DAC 404 shown in FIG. 4 and DACs 804a and 804b shown in FIGS. 8A and 8B) is then used to draw a configured amount of charge from the capacitor, where the charge is equal to the current drawn by the DAC multiplied by the duration of the current. The DAC is then disabled and the DC/DC converter is activated at a nominal output level. The amount of time it takes for the capacitor to return to the target voltage is timed. The current output by the DC/DC converter at the nominal output level is then equal to the charge removed by the DAC divided by the amount of time it took for the DC/DC converter to charge the capacitor back to the target voltage. In some implementations, a plurality of nominal output levels can be tested such that the appropriate output level for a desired output current can be determined through interpolation.

FIGS. 11A and 11B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 11B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a first set of light sources including a first terminal and a second terminal;
a first capacitor, coupled to the first terminal of the first set of light sources; and
a power management device receiving power from a DC voltage source, including:
a first digital-to-analog converter (DAC) coupled to the first terminal of the first set of light sources, the first DAC configured to cause a plurality of current pulses to flow from the first set of light sources to illuminate the light sources for a first plurality of subframes during a first time period and for a second plurality of subframes during a second time period, and
a first programmable DC/DC converter, an output of which is coupled to the second terminal of the first set of light sources and to the first capacitor,
wherein the first programmable DC/DC converter is configured to:
draw a first substantially constant current from the DC voltage source and provide a first substantially constant output current over substantially the entirety of the first time period, and
draw a second substantially constant current, different from the first substantially constant current, from the DC voltage source and provide a second substantially constant output current over substantially the entirety of the second time period.

2. The apparatus of claim 1, wherein the first plurality of subframe and the second plurality of subframes include subframes corresponding to a single image frame.

3. The apparatus of claim 1, wherein at least one subframe of the first plurality of subframes corresponds to an image frame that is different from the image frame corresponding to another subframe of the first plurality of subframes.

4. The apparatus of claim 1, wherein during the first time period a variation in the magnitude of the first substantially constant current at frequencies greater than a frequency that is an order of magnitude larger than a switching frequency of the first programmable DC/DC converter is less than 2% of an average value of the first substantially constant current during the first time period, and wherein during the second time period a variation in the magnitude of the second substantially constant current at frequencies greater than a frequency that is an order of magnitude larger than a switching frequency of the first programmable DC/DC converter is less than 2% of an average value of the second substantially constant current during the second time period.

5. The apparatus of claim 1, further comprising a display controller coupled to the power management device, and configured to:
provide control messages to the first DAC for causing the plurality of current pulses to flow from the first set of light sources, and
provide control messages to the first programmable DC/DC converter, the control messages including at least a current output level associated with each of the first time period and the second time period,
wherein the first programmable DC/DC converter is configured to provide the first substantially output current and the second substantially constant output current during each of the first time period and the second time period based on the respective current output level.

6. The apparatus of claim 5, wherein the control message further includes an output threshold voltage level associated with each of the first time period and the second time period, and wherein the first programmable DC/DC converter is configured to cease providing an output current during the first time period and the second time period when the output voltage exceeds the respective output threshold voltage level.

7. The apparatus of claim 5, wherein the display controller is configured to estimate a total charge to be flowed through the first set of light sources in illuminating the first set of light sources for each of the first time period and the second time period, and provide the current output level for the first time period based on the total charge estimate for the first time period and provide the current output level for the second time period based on the total charge estimate for the second time period.

8. The apparatus of claim 5, wherein the control messages to the first DAC include values for magnitudes and durations of the current pulses.

9. The apparatus of claim 1, wherein the first programmable DC/DC converter is configured to provide an output voltage equal to at least a minimum voltage needed for the operation of the first DAC.

10. The apparatus of claim 1, further comprising
a second set of light sources including a first terminal and a second terminal, the second set of light sources corresponding to a color different from the color corresponding to the first set of light sources, wherein the second terminal of the second set of light sources is coupled to the output of the first programmable DC/DC converter and to the first capacitor,
wherein the power management device further includes a second digital-to-analog converter (DAC) coupled to the first terminal of the second set of light sources, the second DAC configured to cause a plurality of current pulses to flow from the second set of light sources over the first time period and the second time period.

11. The apparatus of claim 1, further comprising:
a second set of light sources including a first terminal and a second terminal, the second set of light sources corresponding to a color different from the color corresponding to the first set of light sources; and
a second capacitor, one terminal of which is coupled to the first terminal of the second set of light sources
wherein power management device further includes:
a second digital-to-analog converter (DAC) coupled to the first terminal of the second set of light sources, the second DAC configured to cause a plurality of current pulses to flow from the second set of light sources over the first time period and the second time period, and
a second programmable DC/DC converter, an output of which is coupled to the second terminal of the second set of light sources and to the second capacitor,
wherein the second programmable DC/DC converter is configured to draw a third substantially constant current from the DC voltage source and provide a third substantially constant output current over the first time period, and draw a fourth substantially constant current, different from the third substantially constant current, from the DC voltage source and provide a fourth substantially constant output current over the second time period.

12. The apparatus of claim 1, further comprising:
a display;
a processor capable of communicating with the display, the processor being capable of processing image data; and
a memory device capable of communicating with the processor.

13. The apparatus of claim 12, further comprising:
a driver circuit capable of sending at least one signal to the display; and
a controller capable of sending at least a portion of the image data to the driver circuit.

14. The apparatus of claim 12, further comprising:
an image source module capable of sending the image data to the processor, wherein the image source module includes at least one of a receiver, transceiver, and transmitter.

15. The apparatus of claim 12, further comprising:
an input device capable of receiving input data and communicating the input data to the processor.

16. A method for providing power to a light source from a power management integrated circuit (PMIC), the PMIC having an output terminal to which the light source and a capacitor are coupled, comprising:
determining an output sequence for displaying a first plurality of subframes during a first time period and a second plurality of subframes during a second time period according to a time division multiplexing image formation process, the output sequence indicating light source illumination levels and durations for each of the first and second plurality of subframes;
providing a plurality of current pulses to the light source from the PMIC, the plurality of current pulses corresponding to the first and the second plurality of subframes;
drawing a first substantially constant current from a DC voltage source powering the PMIC and providing a first substantially constant output current over substantially the entirety of the first time period; and
drawing a second substantially constant current, different from the first substantially constant current, from the DC voltage source and providing a second substantially constant output current over substantially the entirety of the second time period.

17. The method of claim 16, wherein determining an output sequence for displaying a first plurality of subframes during a first time period and a second plurality of subframes during a second time period includes determining an output sequence for displaying the first plurality of subframes and the second plurality of subframes in a single image frame.

18. The method of claim 16, wherein determining an output sequence for displaying a first plurality of subframes during a first time period and a second plurality of subframes during a second time period includes determining an output sequence for displaying at least one subframe of the first plurality of subframes during a first image frame and displaying another subframe of the first plurality of subframes during a second image frame, different from the first image frame.

19. The method of claim 16, wherein drawing a first substantially constant current from the DC voltage source includes drawing a current, which during the first time period and at frequencies greater than a frequency that is an order of magnitude larger than a switching frequency of the PMIC, has variations in magnitude that are less than 2% of an average value of the current over the first time period, and wherein drawing a second substantially constant current from the DC voltage source includes drawing a current, which during the second time period and at frequencies greater than a frequency that is an order of magnitude larger than a switching frequency of the PMIC, has variations in magnitude that are less than 2% of an average value of the current over the second time period.

20. The method of claim 16, wherein providing the first substantially constant output current includes estimating a total charge to be flowed through the light source for illuminating the light source over the first time period and adjusting the level of the first substantially constant output current to sufficiently provide the estimated total charge over the first time period, and wherein providing the second substantially constant output current includes estimating a total charge to be flowed through the light source for illuminating the light source over the second time period and adjusting the level of the second substantially constant output current to sufficiently provide the estimated total charge over the second time period.

21. An apparatus comprising:
first light emitting means for emitting light of a first color responsive to current flow, including a first terminal and a second terminal, wherein the first terminal is coupled to a first capacitor; and
a power management device receiving power from a DC voltage source, including:
first digital-to-analog converting (DAC) means coupled to the first terminal of the first light emitting means for causing a plurality of current pulses to flow from the first light emitting means to illuminate the first light emitting means for a first plurality of subframes during a first time period and for a second plurality of subframes during a second time period, and
first programmable DC/DC converting means, an output of which is coupled to the second terminal of the first light emitting means and to the first capacitor, for drawing a first substantially constant current from the DC voltage source and provide a first substantially constant output current over substantially the entirety of the first time period and for drawing a second substantially constant current, different from the first substantially constant current, from the DC voltage source and provide a second substantially constant output current over substantially the entirety of the second time period.

22. The apparatus of claim 21, wherein the first plurality of subframes and the second plurality of subframes include subframes corresponding to a single image frame.

23. The apparatus of claim 21, wherein at least one subframe of the first plurality of subframes corresponds to an image frame that is different from the image frame corresponding to another subframe of the first plurality of subframes.

24. The apparatus of claim 21, further comprising display controlling means coupled to the power management device, for:
providing control messages to the first DAC means for causing the plurality of current pulses to flow from the first light emitting means, and
providing control messages to the first programmable DC/DC converting means, the control messages including at least a current output level associated with each of the first time period and the second time period,
wherein the first programmable DC/DC converting means is configured to provide an average output current during each of the first time period and the second time period based on the respective current output level.

25. The apparatus of claim 21, further comprising
a second light emitting means for emitting light of a second color responsive to current flow, including a first terminal and a second terminal, the second color being different from the first color, wherein the second terminal of the second light emitting means is coupled to the output of the first programmable DC/DC converting means and to the first capacitor,
wherein the power management device further includes a second digital-to-analog converting (DAC) means coupled to the first terminal of the second light emitting means for causing a plurality of current pulses to flow from the second set of light sources over the first time period and the second time period.

26. The apparatus of claim 21, further comprising:
a second light emitting means for emitting light of a second color responsive to current flow, including a first terminal and a second terminal, the second color being different from the first color; and
a second capacitor, one terminal of which is coupled to the first terminal of the second light emitting means,
wherein the power management device further includes:
a second digital-to-analog converting (DAC) means coupled to the first terminal of the second light emitting means for causing a plurality of current pulses to flow from the second light emitting means over the first time period and the second time period, and
a second programmable DC/DC converting means, an output of which is coupled to the second terminal of the second set of light sources and to the second capacitor, for drawing a third substantially constant current from the DC voltage source and providing a third substantially constant output current over the first time period, and for drawing a fourth substantially constant current, different from the third substantially constant current, from the DC voltage source and providing a fourth substantially constant output current over the second time period.

27. A non-transitory computer readable storage medium having instructions encoded thereon, which when executed by a processor cause the processor to perform a method for providing power to a light source from a power management integrated circuit (PMIC), the PMIC having an output terminal to which the light source and a capacitor are coupled, comprising:
determining an output sequence for displaying a first plurality of subframes during a first time period and a second plurality of subframes during a second time period according to a time division multiplexing image formation process, the output sequence indicating light source illumination levels and durations for each of the first and second plurality of subframes;
providing a plurality of current pulses to the light source from the PMIC, the plurality of current pulses corresponding to the first and the second plurality of subframes;
drawing a first substantially constant current from a DC voltage source powering the PMIC and providing a first substantially constant output current over substantially the entirety of the first time period; and
drawing a second substantially constant current, different from the first substantially constant current, from the DC voltage source and providing a second substantially constant output current over substantially the entirety of the second time period.

28. The method of claim 27, wherein determining an output sequence for displaying a first plurality of subframes during a first time period and a second plurality of subframes during a second time period includes determining an output sequence for displaying the first plurality of subframes and the second plurality of subframes in a single image frame.

29. The method of claim 27, wherein determining an output sequence for displaying a first plurality of subframes during a first time period and a second plurality of subframes during a second time period includes determining an output sequence for displaying at least one subframe of the first plurality of subframes during a first image frame and displaying another subframe of the first plurality of subframes during a second image frame, different from the first image frame.

30. The method of claim 27, wherein providing the first substantially constant output current includes estimating a total charge to be flowed through the light source for illuminating the light source over the first time period and adjusting the level of the first substantially constant output current to sufficiently provide the estimated total charge over the first time period, and wherein providing the second substantially constant output current includes estimating a total charge to be flowed through the light source for illuminating the light source over the second time period and adjusting the level of the second substantially constant output current to sufficiently provide the estimated total charge over the second time period.
